(19) United States
(12) Patent Application Publication
(10) Pub. No.: US 2024/0116381 A1
(43) Pub. Date: Apr. 11, 2024

(54) VEHICULAR IN-CABIN MANUALLY OPERATED POWER GENERATOR FOR POWERING VEHICULAR ACCESSORY

(71) Applicant: Magna Electronics Inc., Auburn Hills, MI (US)

(72) Inventors: Jeremy J. Baca, Ann Arbor, MI (US); Naresh Ravuri, Novi, MI (US)

(21) Appl. No.: 18/482,993

(22) Filed: Oct. 9, 2023

Related U.S. Application Data
(60) Provisional application No. 63/378,902, filed on Oct. 10, 2022.

(51) Int. Cl. B60L 53/57; A63B 22/06; B60L 1/00; B60L 50/60

(52) U.S. Cl. CPC B60L 53/57; A63B 22/0664; A63B 22/0694; B60L 1/00; B60L 50/60

(57) ABSTRACT

A vehicular power generation system includes a power generating device disposed at a vehicle. The power generating device generates electricity responsive to manual operation of an input component of the power generating device by an occupant within an interior cabin of the vehicle. Responsive to the occupant manually operating the input component of the power generating device, the vehicular power generation system outputs electricity generated by the power generating device to electrically charge a battery of the vehicle or electrically power an electrical device within the vehicle.

### CROSS REFERENCE TO RELATED APPLICATION

The present application claims the filing benefits of U.S. provisional application Ser. No. 63/378,902, filed Oct. 10, 2022, which is hereby incorporated herein by reference in its entirety.

### FIELD OF THE INVENTION

The present invention relates generally to a vehicular power generator.

### BACKGROUND OF THE INVENTION

It is known to provide electrically powered vehicular accessories and components, including infotainment systems, headlights, windshield wipers, and windows. Typically, these electrically powered components are powered by a battery or by electric current generated by an alternator of the vehicle. The alternator also charges the battery while the vehicle is driven. In electric vehicles, the batteries that store energy for driving the vehicle are commonly recharged at stationary charging stations or regenerative braking techniques that generate power to charge the batteries when the brakes are applied while the vehicle is moving.

### SUMMARY OF THE INVENTION

A vehicular power generation system includes a battery module configured to store energy. Energy stored by the battery module is used to electrically operate a system of a vehicle equipped with the vehicular power generation system. A power generating device is disposed at an interior portion of the vehicle. The power generating device generates electricity responsive to a force applied at an input component of the power generating device. The power generating device is configured to receive the force at the input component from an occupant of the vehicle. Responsive to the occupant applying the force at the input component of the power generating device, the vehicular power generation system feeds electricity generated by the power generating device to the battery module to electrically charge the battery module.

These and other objects, advantages, purposes and features of the present invention will become apparent upon review of the following specification in conjunction with the drawings.

### BRIEF DESCRIPTION OF THE DRAWINGS

FIG. 1 is a perspective view of an interior cabin of a vehicle equipped with a vehicular power generation system.

### DESCRIPTION OF THE PREFERRED EMBODIMENTS

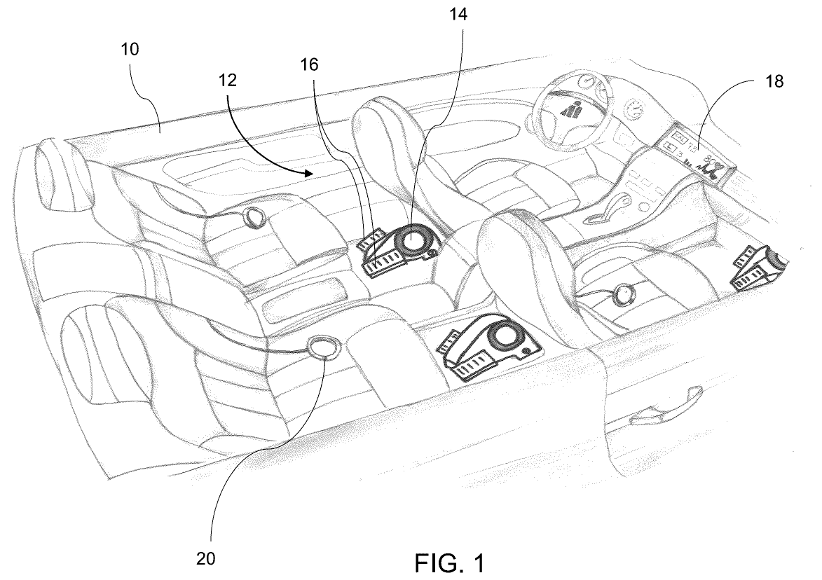

Referring now to the drawings and the illustrative embodiments depicted therein, a vehicle 10 includes a vehicular power generator or generation system 12 that generates electrical power when an occupant of the vehicle manually applies a force or movement to an input module 14 of the system 12 (FIG. 1). The power generation system 12 uses the manual force or movement of the input module 14 to generate electricity to charge the vehicle's battery and/or to electrically power electronic vehicular accessories. The vehicle 10 may have an electric drive system, where a main battery of the vehicle 10 electrically powers a drive system of the vehicle, and the vehicle 10 may have electrically powered vehicular accessories that are electrically powered by the same main battery powering the electric drive system or by an auxiliary battery dedicated to powering one or more vehicular accessories. Thus, the power generation system 12 may generate electricity to charge the battery or batteries that power the electric drive system or an auxiliary battery that powers vehicular accessories, and/or the power generation system 12 may directly power the vehicular accessories.

As shown in FIG. 1, the input module 14 comprises an elliptical or bicycle or other suitable type of exercise module 14 that is disposed at the interior cabin of the vehicle, such as in the floor or foot well of the vehicle. In the illustrated example, an individual exercise module 14 is disposed in the floor in front of the front passenger seat, and the rear driver side and passenger side seats. An exercise module 14 is not disposed in front of the driver seat to avoid distraction or interference with the driver's ability to operate the vehicle. Optionally, an exercise module 14 may be disposed in front of the driver seat when the vehicle has fully autonomous driving capabilities. That is, if the vehicle is equipped with autonomous driving control where operation of the vehicle (e.g., steering, acceleration, and braking) may be fully controlled by an advanced driving assist system (ADAS) of the vehicle, then an exercise module 14 may be disposed in front of the driver's seat.

Each exercise module 14 includes one or more pedals 16 or other suitable inputs at which the occupant may apply a force or motion input. For example, the occupant may push on the pedals 16 of an elliptical module 14. As the occupant applies force to the input 16, the power generation system 12 generates electricity for charging the battery of the vehicle or powering the vehicular accessories. The exercise module 16 may include any suitable exercise module or cardiovascular exercise equipment with an input that allows the occupant to create movement or apply force significant enough to generate electricity. For example, the exercise module may include a stationary bicycle, an elliptical, a rowing machine, a leg press, a cable pull, or a stair climber.

Moreover, one or more display screens 18 may be disposed in the vehicle and operable to display images related to the occupants' performance and output on the exercise module 14. For example, the display screen 18 may display information such as calories burned, time exercised, power generated, and the like. The power generation system 12 may include health monitors 20, such as wrist straps with integrated heart rate monitors, that communicate with the power generation system (via wired or wireless communication) so that, when worn by the vehicle occupants, the power generation system 12 may receive health information (e.g., heart rate, blood oxygen saturation, blood pressure, and the like) about the vehicle occupants. The health information may be displayed on the screen 18 and/or processed to determine whether the power generation system 12 should allow the vehicle occupant to continue exercising. For example, the power generation system 12 may communicate a message alerting the exercising occupant to a health concern and/or lock movement of the exercise module 14 if a threshold period of exercise or threshold heart rate is detected. Furthermore, the power generation system 12 may wirelessly communicate with smart watches or personal mobile devices associated with the vehicle occupants to determine health information.

Thus, the power generation system includes an electronic control unit (ECU) including electronic circuitry and associated software, including a data processor for processing data received from the health monitor 20, smart watch, and/or exercise module 14 and for generating images for display at the display screen 18. The ECU may include a wireless communications module, such as a transmitting and receiving antenna for communicating with wireless devices within the vehicle.

Optionally, the vehicle may comprise a mass transportation vehicle, such as a bus or shuttle, configured to transport a large number of passengers and having a larger and more open interior cabin than a traditional passenger vehicle. Some or all of the passenger seats may have an exercise module at them so a person sitting in the seat may perform workouts and exercise. Optionally, in such larger mass transportation vehicles, the exercise module 14 may include one or more exercise machines, such as a stationary bicycle, a treadmill, a rowing machine, and the like, fixedly mounted within the cabin of the mass transportation vehicle. The mass transportation vehicle provides greater interior space to allow the vehicle occupant to perform more traditional exercise motions, and the occupant may generate a greater amount of energy for charging batteries and/or operating auxiliary systems of the vehicle.

Thus, while driving, passengers can perform workouts and exercise in the vehicle with elliptical or bicycle installed under the dashboard for front passenger and under the front seat or back of the front seat for rear passengers. The exercise module is adjustable to ensure accessibility for the occupants' feet and/or hands. Workout details may be shown on the center console screen for individual passengers (e.g., calories burned, steps, etc.). The driver seat may have an exercise module as well, in case of Level 5 autonomy vehicle. Health wrist bands may be provided for each passenger and used to track vitals. Vitals will be available to track on the center console display screen. Smart watches may be connected to the infotainment system so that the system may display occupants' vitals while operating the elliptical/bike. Thus, the power generation system improves the health of passengers, saves time spent on physical activities, and allows the occupants to spend quality time while in the vehicle.

Power generated through the bike/elliptical may be used to recharge the main battery and in turn increases the miles per battery available in a single full external charge. Optionally, power generated through the bike/elliptical may be used to recharge dedicated the secondary or auxiliary battery to power noncritical ECUs (e.g., for infotainment systems, climate control systems, and the like). This extends the fully electric vehicle range for a single charge by adding in-cabin power generation methods.

As discussed above, the vehicle 10 may be equipped with an auxiliary battery for powering non-critical electronic vehicular accessories, such as the infotainment and audio system, heating, ventilation and air conditioning (HVAC) system, interior cabin lighting, and the like. In other words, non-critical systems of the vehicle may be powered by the auxiliary battery instead of the main battery that powers the drive system of the vehicle. The auxiliary battery may be separably chargeable from the main battery, such as via the power generation system 12, regenerative braking, or external charging.

By powering the vehicular accessories using the separate, auxiliary battery, the power draw from the main battery may be limited to power draw required to operate the vehicle and battery life and battery range of the vehicle may be preserved. In other words, the dedicated small battery for the infotainment system will decrease main battery usage and increase the number of miles the vehicle may travel per single external charge of the main battery. The dedicated small battery may be charged from an external power source and from power generated from the wheels of the vehicle (i.e., regenerative braking). The infotainment console, speakers, and non-critical ECUs may be operated by using the auxiliary battery. Saving battery charge of the main battery will improve miles per charge.

Moreover, when the vehicle is moving and regenerative braking techniques are generating electricity, such as to recharge the main battery, this power generated may be used to directly power the infotainment systems and other non-critical vehicular accessories of the vehicle. That is, rather than storing the energy at the main battery or auxiliary battery, the generated electricity may directly power the vehicular accessories.

Thus, power generated (direct current (DC)) from vehicle e-motor/wheels may be directly supplied to non-critical ECUs while the vehicle is running and operating. The infotainment system and other non-critical vehicular accessories may have a backup battery connection for when the vehicle is not generating enough power to operate the accessories or the vehicle is not moving. Generated power can be used as auxiliary in-cabin supply. This saves power from the main battery and improves miles per charge.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular electrical power generation system, the vehicular electrical power generation system comprising:
an electrical power generating device disposed at a vehicle equipped with the vehicular electrical power generation system, wherein the electrical power generating device generates electricity responsive to manual operation of an input component of the electrical power generating device by an occupant within an interior cabin of the vehicle; and
wherein, responsive to the occupant manually operating the input component of the electrical power generating device, the vehicular electrical power generation system outputs electricity generated by the electrical power generating device to at least one selected from the group consisting of (i) electrically charge a battery of the vehicle and (ii) electrically power an electrical device within the vehicle.

2. The vehicular electrical power generation system of claim 1, wherein the input component comprises one or more foot pedals configured to be manually operated by the occupant of the vehicle.

3. The vehicular electrical power generation system of claim 2, wherein the one or more foot pedals are a component of an exercise module of the vehicle.

4. The vehicular electrical power generation system of claim 3, wherein the exercise module comprises a bicycle module.

5. The vehicular electrical power generation system of claim 3, wherein the exercise module comprises an elliptical module.

6. The vehicular electrical power generation system of claim 1, further comprising a display screen disposed within the interior cabin of the vehicle, wherein the display screen is operable to display information based on manual operation of the input component.

7. The vehicular electrical power generation system of claim 1, wherein a health monitor is in communication with the vehicular electrical power generation system, and wherein the vehicular electrical power generation system receives information from the health monitor, the received information comprising health information related to the occupant manually operating the input component.

8. The vehicular electrical power generation system of claim 1, wherein energy stored by the battery is used to electrically power an electric drive system of the vehicle that, when electrically operated, is operable to move the vehicle in a forward or rearward direction.

9. The vehicular electrical power generation system of claim 1, wherein the battery comprises an auxiliary battery of the vehicle, and wherein the auxiliary battery is used to electrically operate an accessory of the vehicle.

10. The vehicular electrical power generation system of claim 1, wherein the vehicular electrical power generation system outputs electricity generated by the electrical power generating device to electrically power a cell phone within the vehicle.

11. A vehicular electrical power generation system, the vehicular electrical power generation system comprising:
an electrical power generating device disposed at a vehicle equipped with the vehicular electrical power generation system, wherein the electrical power generating device generates electricity responsive to manual operation of one or more foot pedals of the electrical power generating device by an occupant within an interior cabin of the vehicle;
a health monitor in communication with the vehicular electrical power generation system, wherein the vehicular electrical power generation system receives information from the health monitor, the received information comprising health information related to the occupant manually operating the one or more foot pedals of the electrical power generating device; and
wherein, responsive to the occupant manually operating the one or more foot pedals of the electrical power generating device, the vehicular electrical power generation system outputs electricity generated by the electrical power generating device to at least one selected from the group consisting of (i) electrically charge a battery of the vehicle and (ii) electrically power an electrical device within the vehicle.

12. The vehicular electrical power generation system of claim 11, wherein the one or more foot pedals are a component of an exercise module of the vehicle.

13. The vehicular electrical power generation system of claim 12, wherein the exercise module comprises a bicycle module.

14. The vehicular electrical power generation system of claim 12, wherein the exercise module comprises an elliptical module.

15. The vehicular electrical power generation system of claim 11, wherein information based on manual operation of the one or more foot pedals of the electrical power generating device is displayed on a display screen within the interior cabin of the vehicle.

16. The vehicular electrical power generation system of claim 11, wherein the battery comprises an auxiliary battery of the vehicle, and wherein the auxiliary battery is used to electrically operate an accessory of the vehicle.

17. The vehicular electrical power generation system of claim 11, wherein the vehicular electrical power generation system outputs electricity generated by the electrical power generating device to electrically power a cell phone within the vehicle.

18. A vehicular electrical power generation system, the vehicular electrical power generation system comprising:
an electrical power generating device disposed at a vehicle equipped with the vehicular electrical power generation system, wherein the electrical power generating device generates electricity responsive to manual operation of an input component of the electrical power generating device by an occupant within an interior cabin of the vehicle;
a display screen disposed within the interior cabin of the vehicle, wherein the display screen is operable to display information based on manual operation of the input component of the electrical power generating device;
wherein, responsive to the occupant manually operating the input component of the electrical power generating device, the vehicular electrical power generation system outputs electricity generated by the electrical power generating device to electrically charge an auxiliary battery of the vehicle; and
wherein the auxiliary battery is used to electrically operate an accessory of the vehicle.

19. The vehicular electrical power generation system of claim 18, wherein the input component comprises one or more foot pedals configured to be manually operated by the occupant of the vehicle.

20. The vehicular electrical power generation system of claim 18, wherein a health monitor is in communication with the vehicular electrical power generation system, and wherein the vehicular electrical power generation system receives information from the health monitor, the received information comprising health information related to the occupant manually operating the input component.
